(19) United States
(12) Patent Application Publication
(10) Pub. No.: US 2006/0210154 A1
(43) Pub. Date: Sep. 21, 2006

(54) Skin tone measurement device and method

(75) Inventors: Jean-Luc Leveque, Paris (FR); Roland Bazin, Bievres (FR)

Correspondence Address: OLIFF & BERRIDGE, PLC, P.O. BOX 19928, ALEXANDRIA, VA, 22320, US

(73) Assignee: L'OREAL, Paris (FR)

(21) Appl. No.: 11/374,973

(22) Filed: Mar. 15, 2006

Related U.S. Application Data
(60) Provisional application No. 60/694,993, filed on Jun. 30, 2005.

(30) Foreign Application Priority Data
Mar. 15, 2005 (FR) 05 50667

(51) Int. Cl. G06K 9/00

(52) U.S. Cl. 382/165; 382/115

(57) ABSTRACT

A device for evaluating skin tone may include a measurement head configured to be applied against skin. The measurement head may include: an outlet window through which light is to be emitted into the skin; and a detection window configured to receive the light emitted through the outlet window. A distance between the outlet window and the detection window may be selected in such a manner that at least a major fraction of the light emitted from the outlet window travels through the skin over a distance of at least 1 mm prior to reaching the detection window. The device may also include a non-colorimetric detection system configured to deliver a signal that is representative of a light intensity of the light received by the detection window.

### CROSS-REFERENCE TO RELATED APPLICATIONS

This non-provisional application claims the benefit of French Application No. 05 50667 filed on Mar. 15, 2005and U.S. Provisional Application No. 60/694,993 filed on Jun. 30, 2005, the entire disclosures of which are incorporated herein by reference.

### BACKGROUND

The present invention relates to devices and methods that enable physical and biological characteristics of skin to be evaluated.

European patent EP 0 655 221 B1 describes a method that enables internal color of skin to be determined. According to that method, a calorimetric measurement head is pressed against the skin. Light that leaves the skin after being diffused in deep layers thereof is analyzed colorimetrically.

International patent application WO 88/05284 describes an apparatus for determining a sunscreen protection index. The apparatus includes a light-emitting diode (LED) emitting green light and a photovoltaic cell.

German patent application DE 40 31 320 describes a device that includes a measurement head for pressing against skin to analyze spectral distribution of light diffused by the skin.

French patent application FR 2 658 410 describes an apparatus for measuring a degree of skin coloring. The apparatus includes a photocell arranged to receive a light beam reflected by the skin.

British patent application GB 2 022 244 describes a device for studying jaundice, which includes a light receiver provided with blue and green filters.

### SUMMARY

There exists a need to benefit from means that enable skin tone to be evaluated.

The term “tone” is used herein to cover more than a notion of color alone, and extends to cover behavior of the skin in response to incident light.

Tone is thus also a function of irrigation of the skin by blood and of a density of hair follicles, which behave somewhat like light traps in the presence of incident light.

Exemplary embodiments of the present invention may provide a device for evaluating skin tone, the device comprising: a measurement head configured to be pressed against skin, the head including: an outlet window through which light, for example, visible light, may be emitted into the skin; and a detection window configured to receive the light emitted through the outlet window, the distance between the outlet window and the detection window may be selected in such a manner that at least a major fraction of the light emitted from the outlet window travels through the skin over at least 1 millimeter (mm), better at least 3 mm or 5 mm, better still at least 7 mm, prior to reaching the detection window; and a non-colorimetric detection system configured to deliver a signal that is representative of a light intensity of the light received by the detection window.

In exemplary embodiments, the distance traveled through the skin may lie in a range of about 1 mm to about 10 mm, for example.

In exemplary embodiments, the measurement head may be configured to create at least two different light paths through the skin, for example, of different lengths and/or different orientations.

The term “non-colorimetric detection system” is used to mean a detection system that delivers information unsuitable for determining coordinates in a colorimetric space of light received by the detection window.

For example, the non-colorimetric detection system may exclude means for analyzing a reflectance spectrum.

The term “window” should not be understood restrictively, and covers any region suitable for emitting or receiving light. A window may be defined by an opening through a wall of the device, but may be defined otherwise.

In use, when the measurement head is pressed against the skin, the detection window receives light from the outlet window only after the light has diffused through the skin. This light may propagate along a path that is long enough in deep layers of the skin for the detected intensity to vary significantly between individuals considered not to have the same skin tone.

The measured light intensity may depend, for example, on greater or smaller density of hair follicles, with a high density of follicles generally being associated with greater blood supply.

Furthermore, because exemplary embodiments use a detection system that is not colorimetric, exemplary embodiments of the invention may be simple to make and reliable in operation.

In exemplary embodiments, the distance between the outlet window and the detection window, when relatively large, may make it possible to take into account an influence of relatively deep layers of the skin on tone.

In exemplary embodiments, the device may include a light source that is a source of white light, for example, one or more incandescent bulbs or white LEDs. In other exemplary embodiments, the light emitted from the outlet window may lie in the infrared domain or the ultraviolet domain.

Depending on requirements, exemplary embodiments of the device may include at least one optical filter configured to filter the light received by the detection window, for example, a green, yellow, or red filter.

In exemplary embodiments, the device may include at least one monochromator or filter on emission and/or reception.

In exemplary embodiments, the light sent into the skin may be caused to be substantially monochromatic, for example, by using a filter, a monochromator, or a monochromatic light source.

In other exemplary embodiments, the detected light may be monochromatic while the emitted light is not, for example, by using a filter or a monochromator on reception.

In exemplary embodiments, the light source may be modulated in intensity, thus making it possible to use synchronous detection to avoid an influence of ambient light.

In exemplary embodiments, the measurement head may include any sensor that is sensitive to light, whether visible or not, for example, a photovoltaic cell, a phototransistor, a photodiode, or a linear sensor or a matrix sensor capable of delivering an electrical signal that is a function of the light intensity it picks up.

In exemplary embodiments, the use of a linear or matrix sensor may serve to obtain information about the way in which the received light intensity decreases as a function of distance.

In exemplary embodiments, the detection system may deliver a signal that is digital or analog.

For example, the detection system may deliver an electrical voltage or current that varies as a function of the light received by the detection window. The voltage or current may be transformed into alphanumeric information that may be read from a display, for example.

In exemplary embodiments, the detection system may include calibration means for enabling prior calibration to be performed, and, for example, may include means for setting a gain and/or a zero point. The detection system may be calibrated by using a block of material that includes predefined optical properties, for example, a block of plastics material foam, for example, made of polyethylene, and, for example, as sold under the name Tresylene.

In exemplary embodiments, the measurement device may be configured to be held in one hand only, for example, being powered by at least one optionally rechargeable battery.

In exemplary embodiments, the measurement device may be self-contained, for example, including a display or other means for issuing information, for example, a dial with a needle, a liquid-crystal display (LCD) display, or an LED display, an LCD screen, an organic light-emitting diode (OLED) screen, a plasma screen, and the like, and/or may include one or more indicator lights.

In exemplary embodiments, the device may include display means that enables understandable information to be delivered to directly inform the user about results of the tone evaluation, for example, a score or an alphanumeric message that is more complex.

In exemplary embodiments, the measurement device may also be configured to transmit data or exchange data with a terminal, for example, a computer, a digital assistant, or a mobile telephone. Data may be exchanged over a wired or wireless link. The terminal may then run a program that enables the signals coming from the measurement device to be processed.

Where appropriate or desired or desired, the measurement device may include at least one other sensor for measuring some other physicochemical magnitude of the skin, for example, temperature, humidity, sebum, a biosensor, and the like.

In exemplary embodiments, the measurement device may also include a pressure sensor or any other means that enables the measurement head to be pressed against the skin with sufficient pressure to expel hemoglobin therefrom.

For example, the measurement head may be mounted on a resilient return system that enables the head to be pressed against the skin with a predefined pressure.

Exemplary embodiments of the present invention may provide, independently or in combination with the above, a device comprising a measurement head configured to be pressed against skin, said measurement head being configured in such a manner as to create through the skin at least two light paths of different lengths and/or of different orientations, and a detection system configured to measure corresponding light intensities.

Where appropriate or desired, the detection system may determine a color of the light that has passed through the skin or an attenuation of the light as a function of wavelength.

In exemplary embodiments, the two light paths may be created using at least three windows, for example.

For example, the device may include an outlet window and two detection windows situated at different distances from the outlet window and/or at different angular orientations relative to the outlet window.

In exemplary embodiments, the device may also include at least one light source and a matrix sensor and/or a linear sensor that enables an intensity and/or a color of the light to be detected after traveling along two paths through the skin that are of different lengths and/or different orientations.

In exemplary embodiments, the device may include a processor that responds to the light intensities associated with the different paths by delivering information suitable for comparing optical properties of the skin at different depths.

In exemplary embodiments, the sensed light may be detected, for example, in parallel through each of the detection windows. Alternatively, the sensed light may be detected sequentially.

In exemplary embodiments, the two light paths may be substantially orthogonal or may be colinear, or indeed may be defined with a predefined angle between each other.

In exemplary embodiments, the device may include one outlet window and a plurality of detection windows that are disposed at equal angles around the outlet window, and optionally at a constant distance therefrom.

In exemplary embodiments, there may be three or more detection windows, for example, twelve windows spaced apart at an angle of 30° between adjacent detection windows.

Exemplary embodiments of the present invention may provide a method of evaluating physical and biological properties of skin, for example, tone, in which use is made of a device as defined above that has two or more windows, the measurement head being pressed against the skin in such a manner as to expel hemoglobin therefrom while taking the measurement.

For example, two measurements taken in two different regions of the body may illustrate that there is a difference in tone between the two regions and that there is a need to apply locally on one of them a substance suitable for acting on blood microcirculation, sebum secretion, or skin thickness (thickness of the epidermis or of the dermis), for example.

Exemplary embodiments of the present invention may provide a method of evaluating physical and biological properties of skin, for example tone, in which measurements are made of an attenuation of light traveling through the skin along two different paths having different lengths and/or different orientations.

In exemplary embodiments in which the device used has only two measurement windows, it is possible to change the orientation of the device between taking the measurements.

In exemplary embodiments in which the device used is configured to create light paths in the skin that are not colinear, for example, being substantially orthogonal, and in which the device includes, for example, at least three windows for this purpose, the measurement of light attenuation along the two paths may be performed without any need to move the device or to change its orientation between taking measurements.

For example, the device may include a processor that, for example, compares at least two values resulting from measurements taken along at least two different orientations relative to the skin, for example, two orientations that are substantially perpendicular to each other, or a plurality of orientations that are regularly spaced apart.

For example, such an approach may reveal an orientation of collagen bundles in the skin, from which information relating to the state of aging of the skin, for example, may be deduced.

Exemplary embodiments of the present invention may provide a method of revealing an effect of a treatment on physical and biological characteristics of skin, for example tone, for example, by applying a substance or taking a food supplement, in which at least two evaluations are performed on the skin, before and after treatment, using a device as defined above. The treatment may be medical or non-medical. Where appropriate or desired, the treatment may include taking or applying a medicine.

For example, a value may be given to each measurement, for example, a numerical value, and the before- and after-treatment values may be compared.

Where appropriate or desired, the value obtained may be compared with a value that is to be found in a reference population. The reference population may be constituted, for example, by a population in which the individuals present physiological characteristics and/or body typological characteristics that are comparable with those of the individual on whom the measurement is being performed.

Exemplary embodiments of the present invention may provide a method of prescribing a treatment in which tone is evaluated by using a device as defined above, and a treatment is prescribed as a function of the measurement performed. For example, it is possible to select a treatment such as applying a substance or taking a food supplement on the basis of the evaluation of tone.

Exemplary embodiments of the present invention may provide a method of formulating a personalized cosmetic or dermatological substance in which tone is evaluated by using a device as defined above, and then as a function of information obtained from the evaluation, a content of at least one ingredient used in the formulation of the substance may be determined.

Exemplary embodiments of the present invention may provide a method of promoting sale of a cosmetic, in which reference may be made to an action of the cosmetic on tone as revealed by using a device as defined above.

### BRIEF DESCRIPTION OF THE DRAWINGS

Various details of the present invention may will be better understood on reading the following detailed description of non-limiting embodiments, and on examining the accompanying drawings, which form an integral part of the description, and in which:

FIG. 1 is a diagrammatic perspective view of an exemplary tone-evaluation device;

FIG. 2 is an end view of the device of FIG. 1 seen looking along arrow II;

FIG. 3 is a schematic view of an exemplary detection system;

FIG. 4 illustrates how light is diffused in the skin;

FIG. 5 is a diagram illustrating an exemplary evaluation device, including a spring;

FIG. 6 illustrates the possibility of making an evaluation device that is configured to communicate with a terminal;

FIGS. 7 and 8 are two views analogous to FIG. 2 illustrating two other exemplary embodiments;

FIG. 9 is a view analogous to FIG. 3, illustrating another exemplary embodiment; and

FIGS. 10 and 11 are two other views analogous to FIG. 2, illustrating other exemplary embodiments.

### DETAILED DESCRIPTION OF EMBODIMENTS

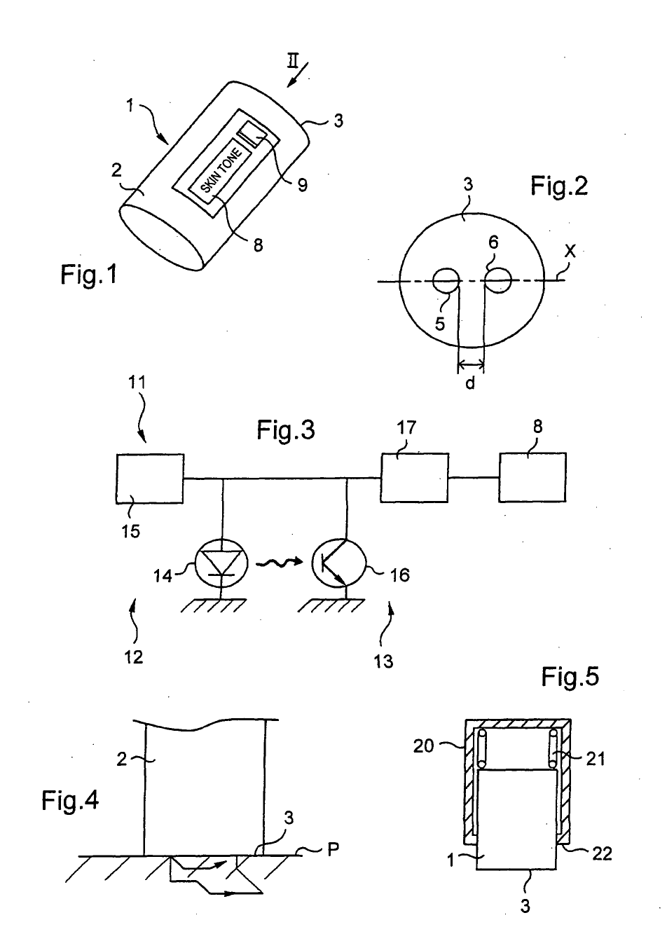

An exemplary tone-evaluation device 1 illustrated in FIG. 1 may comprise a case 2 including one face 3 that is used as a measurement head by being applied against the skin.

The measurement head may include an outlet window 5 through which light is emitted toward the skin and a detection window 6 for receiving light that has diffused in the skin.

In the exemplary embodiment, a distance d between the windows 5 and 6 may be greater than 5 mm, for example, about 8 mm.

The case 2 may house a self-contained electrical power supply such as at least one optionally rechargeable battery, and may also be provided with a display 8 for delivering information visually about the measurement performed, for example, a numerical value quantifying tone or a magnitude associated therewith.

The device 1 may also include one or more control buttons 9 that enable the device 1 to be switched on, and, where appropriate or desired, to be calibrated, for example, for the purpose of adjusting gain and a zero point. For example, such calibration may be performed by causing light to diffuse between the windows 5 and 6 through a given material, for example, a block of plastics material known under the name Tresylene.

The device 1 may include a detector system 11, for example, as illustrated diagrammatically in FIG. 3.

The detector system 11 may comprise an emitter portion 12 and a receiver portion 13. The emitter portion 12 may comprise, for example, a LED 14, preferably emitting white light, and a power supply circuit for said LED 14, for example, supplying the LED 14 with power at an intensity that is modulated at a constant frequency.

The receiver portion 13 may comprise a light-sensitive sensor 16, for example, a phototransistor or a photodiode, and a measurement circuit 17 connected firstly to the sensor 16 and secondly to the emitter portion 15, so as to performance synchronous detection.

The measurement circuit 17 may include a signal processor, for example, that serves to cause a numerical value to be displayed on the display 8 that is representative of the light intensity detected by the sensor 16.

To use the device 1, the user may press the face 3 against the skin P, as illustrated in FIG. 4.

The light emitted by the LED 14 passes through the outlet window 5 and diffuses into the skin. The diffused light may be detected by the sensor 16 through the detection window 6. No light emitted by the window 5 may reach the window 6 directly without propagating through the skin.

The device 1 may preferably be pressed against the skin at a pressure that is sufficient to expel hemoglobin, which pressure is equal to about 1 kilogram per square centimeter (kg/cm²) or more.

Where appropriate or desired, the device 1 may include a pressure sensor and the detector system may be configured to perform the measurement and/or inform the user when sufficient pressure is exerted on the skin, for example, by displaying a corresponding message on the display 8.

In exemplary embodiments, the device 1 may include means for enabling the face 3 to be pressed against the skin with a predefined force.

In the exemplary embodiment illustrated in FIG. 5, the device 1 may be engaged in an outer case 20 in which there is a spring 21 that is compressed by the device 1 when the device 1 pressed against the skin.

During measurement, the face 3 may be pressed against the skin, for example, until a bottom edge 22 of a case 20 comes to press against the skin. The spring 21 may then be compressed through a predefined stroke, thereby enabling a controlled pressure to be applied to the skin.

The information delivered by the display 8 may be, for example, compared with a corresponding value for a reference population.

The device 1 may be used to reveal anisotropy in light propagation through the skin. For example, the device may include a processor that compares results of measurements taken with the windows 5 and 6 in two different orientations relative to the skin.

The device may include more than two measurement windows.

FIGS. 7 and 9 illustrate another exemplary embodiment in which the face 3 includes an outlet window 5 and two detection windows 6′ and 6″ associated with respective sensors 16′ and 16″.

A distance d₁ between the windows 5 and 6′ is different from a distance d₂ between the windows 5 and 6″, so as to create two light paths of different lengths through the skin.

For example, such a configuration may make it possible to compare the optical properties of the skin at different depths.

Light intensity received through the windows 6′ and 6″ may be detected either simultaneously or sequentially. Where appropriate or desired, sequential detection may make measurement electronics simpler.

An angle α between axes X′ and X″ defined by the windows 5 and 6′ and between the windows 5 and 6″ may lie in a range of 0 to 90°, for example.

When the angle α is zero, the windows 5, 6′, and 6″ are in alignment. For example, a ratio d₂/d₁ may lie in a range of 2 to 10, for example, with d₁=1 mm and d₂=5 mm.

When the angle α is non-zero, for example, being equal to 90°, then d₁ may be equal to d₂ so as to make it possible to compare light attenuation in two different directions, for example, two orthogonal directions, thereby obtaining information concerning the skin and its anisotropy, for example, concerning the state of its collagen and orientation thereof.

The measurement head may also include more than three windows, for example, two outlet windows and two detection windows.

The device may include two outlet windows and one detection window, the outlet windows then emitting light in succession to be received by the detection window.

In another exemplary embodiment, the device may have one outlet window 5 and several, for example, twelve, detection windows 6, as illustrated in FIG. 8.

The detection windows 6 may be disposed at equal angles around the outlet window 5, for example, at an angle β equal to 30° between two adjacent detection windows 6.

Such a configuration may makes it possible to perform measurements in a plurality of different orientations.

In the exemplary embodiment illustrated in FIG. 10, at least one light source 30 and at least one linear sensor 31 may be used. The sensor 31 may comprise a succession of juxtaposed detection cells and may make it possible to analyze a light-intensity profile as a function of distance from the source 30.

Where appropriate or desired, and as illustrated, the device may include at least one second linear sensor 32 so as to be able to analyze an intensity of light that has propagated in a direction perpendicular to the orientation of the sensor 31.

In the exemplary embodiment illustrated in FIG. 11, the device may include at least one source 30 and a matrix sensor 33, for example, of the complementary metal oxide on silicon (CMOS) type or the charge-coupled device (CCD) type, for example, providing a resolution of 512×512.

The device may include analysis means (not illustrated) connected to the sensor 33, for example, for the purpose of analyzing light intensity as a function of the distance from the source 30 in one or more directions.

Naturally, the invention is not limited to the examples described above.

For example, the invention is not limited to one particular means for displaying information delivered by the device 1.

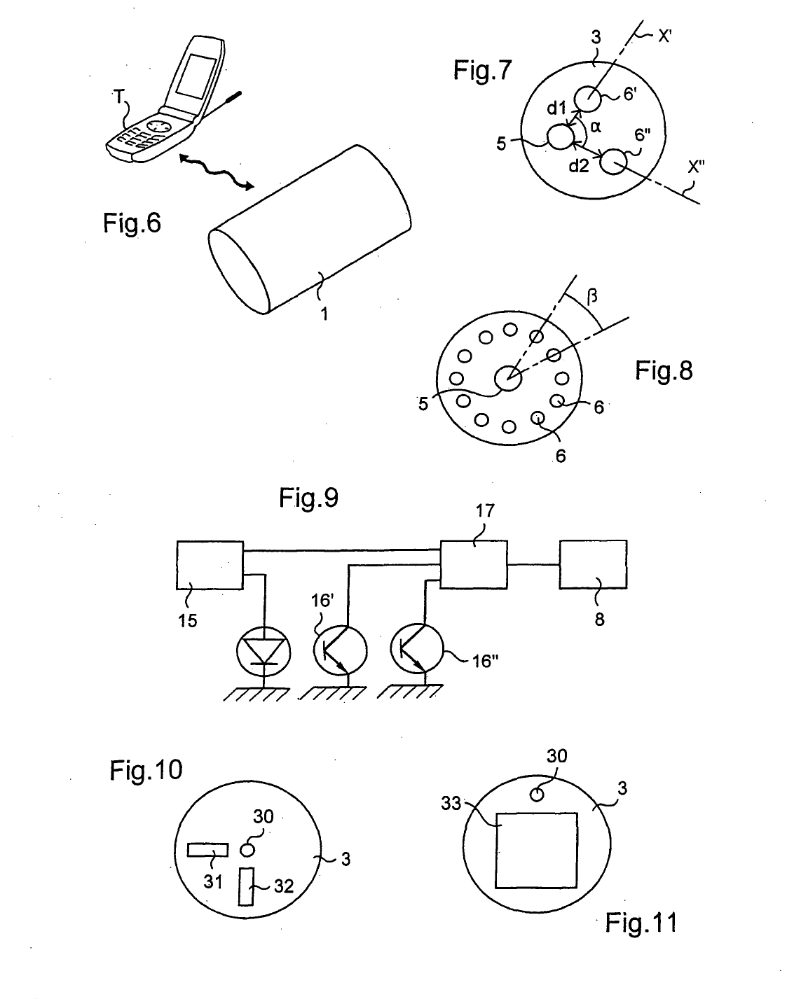

In the exemplary embodiment illustrated in FIG. 6, the device 1 itself does not include a display 8, and, for example, information may be transmitted over a wired or wireless connection to a terminal T, for example, to a computer or to a mobile telephone, which includes a display that is used for informing the user of the measured value.

The terminal T may perform at least part of the information processing.

Where appropriate or desired, the information received by the terminal T may also be transited to a remote site where the information may be processed and the user may receive advice in return, for example, in the form of a prescription or a preparation that has an effect on skin tone.

For example, the device 1 may also be used to measure an effect of a treatment on skin tone.

A first measurement may be performed before treatment, and then a second measurement may be performed after treatment. By comparing values delivered by the device before and after treatment, it may be possible to determine an effectiveness of the treatment.

The device 1 may be used at a point-of-sale or at home.

When the device is used at a point-of-sale, after measuring skin tone, a consumer may receive information relating to a preparation for application to the skin or to a treatment to be followed, for example, taking food supplements.

Where appropriate or desired, a personalized preparation may be formulated at the point-of-sale in view of results of the measurement, or may be prepared and subsequently sent to the consumer at home.

The device 1 may include or may be associated with at least one additional sensor, for example, a sensor of skin hydration or of skin microrelief, together with means for processing signals delivered by said additional sensor(s), to inform the user about skin tone and other skin characteristics as a function of the information coming from the various sensors.

Where appropriate or desired, light detection may be performed in anon-synchronous manner.

The term “comprising a” should be understood as being synonymous with “comprising at least one” unless specified to the contrary.

Although the present invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention.

WHAT IS CLAIMED IS:

1. A device for evaluating skin tone, the device comprising:
a measurement head configured to be applied against skin, the head comprising:
an outlet window through which light is to be emitted into the skin; and
a detection window configured to receive the light emitted through the outlet window, a distance between the outlet window and the detection window being selected in such a manner that at least a major fraction of the light emitted from the outlet window travels through the skin over a distance of at least 1 mm prior to reaching the detection window; and
a non-colorimetric detection system configured to deliver a signal that is representative of a light intensity of the light received by the detection window.

2. A device according to claim 1, wherein the distance over which at least the major fraction of the light emitted from the outlet window through the skin is at least 3 mm prior to reaching the detection window.

3. A device according to claim 1, wherein the distance over which at least the major fraction of the light emitted from the outlet window through the skin is at least 5 mm prior to reaching the detection window.

4. A device according to claim 1, wherein the distance over which at least the major fraction of the light emitted from the outlet window through the skin is at least 7 mm.

5. A device according to claim 1, wherein the non-colorimetric detection system excludes means for analyzing a reflectance spectrum.

6. A device according to claim 1, further comprising a source of white light.

7. A device according to claim 1, wherein the light that is emitted from the outlet window and received by the detection window is infrared light.

8. A device according to claim 1, wherein the light that is emitted from the outlet window and received by the detection window is ultraviolet light.

9. A device according to claim 1, further comprising at least one filter configured to filter the light received by the detection window.

10. A device according to claim 1, further comprising a light source that is modulated in intensity.

11. A device according to claim 1, wherein the measurement head comprises a sensor that is sensitive to light.

12. A device according to claim 11, wherein the sensor comprises at least one of a phototransistor, a photodiode, a linear sensor and a matrix sensor.

13. A device according to claim 1, wherein the detection system comprises calibration means for enabling prior calibration to be performed.

14. A device according to claim 1, further comprising means for enabling the measurement head to be pressed against the skin with a predefined pressure.

15. A device according to claim 1, wherein the device is configured to be held entirely in one hand.

16. A device according to claim 1, wherein the device is configured to at least one of transmit data and exchange data with a terminal.

17. A device according to claim 16, wherein the terminal comprises at least one of a computer, a digital assistant and a mobile telephone.

18. A device according to claim 1, further comprising a processor configured to compare two values that result from measurements performed in two orientations relative to the skin.

19. A device according to claim 1, wherein the device is configured to create at least two light paths through the skin of at least one of different lengths and different orientations, and to measure light intensities corresponding to the at least two light paths.

20. A device according to claim 19, wherein the outlet window comprises one outlet window and the detection window comprises two detection windows situated at different distances from the one outlet window.

21. A device according to claim 14, wherein the outlet window comprises one outlet window and the detection window comprises a plurality of detection windows disposed at equal angle around the one outlet window.

22. A device according to claim 21, wherein the detection windows are disposed at a constant distance from the outlet window.

23. A device according to claim 19, further comprising a processor configured to deliver information about at least one property of the skin depending on at least one of depth and orientation as a function of the corresponding light intensities.

24. A device according to claim 21, wherein the corresponding light intensities are detected in parallel through a respective one of the detection windows.

25. A device according to claim 19, wherein the corresponding light intensities are detected in a sequential manner.

26. A device according to claim 19, wherein the at least two light paths are substantially orthogonal.

27. A device comprising:
a measurement head configured to be pressed against skin, said measurement head being configured to create through the skin at least two light paths of at least one of different lengths and different orientations; and
a detection system configured to measure corresponding light intensities of light after traveling through the skin along the at least two light paths.

28. A device according to claim 27, wherein the at least two paths are substantially colinear.

29. A device according to claim 27, wherein the at least two paths are substantially orthogonal.

30. A device according to claim 27, further comprising a linear sensor configured to analyze intensity of light received at different distances from a source.

31. A device according to claim 27, further comprising a matrix sensor configured to enable intensity of light received at least one of at different distances and different directions from a source to be analyzed.

32. A method of measuring skin tone, comprising:
providing a device comprising:
a measurement head configured to be pressed against skin, said head comprising:
an outlet window through which light is to be emitted; and
a detection window configured to receive the light emitted through the outlet window; and
a non-colorimetric system configured to detect the light received by the detection window, said system being configured to deliver a signal representative of a light intensity of the light received by the detection window; and
pressing the measurement head against the skin in such a manner as to expel hemoglobin therefrom while a measurement is being taken.

33. A method according to claim 32, wherein the measurement head is pressed against the skin at a pressure of about 1 kg/cm².

34. A method of revealing an effect on skin tone of a cosmetic treatment, comprising:
providing a skin tone measurement device as defined in claim 1;
using the device to evaluate skin tone before the cosmetic treatment; and
using the device to evaluate skin tone after the cosmetic treatment.

35. A method using a device for measuring skin tone, comprising:
providing a device comprising:
a measurement head configured to be pressed against skin, said head comprising:
an outlet window through which light is to be emitted; and
a detection window configured to receive the light emitted through the outlet window; and
measuring attenuation of light in the skin along two paths of at least one of different lengths and different orientations using the device, without moving the device relative to the skin.
